(19) United States
(12) Patent Application Publication
(10) Pub. No.: US 2002/0110792 A1
(43) Pub. Date: Aug. 15, 2002

(54) Training method

(76) Inventor: Ernest Mastria, Belmar, NJ (US)

Correspondence Address: BAKER & BOTTS, 30 ROCKEFELLER PLAZA, NEW YORK, NY, 10112

(21) Appl. No.: 10/023,034

(22) Filed: Oct. 30, 2001

Related U.S. Application Data
(60) Provisional application No. 60/248,927, filed on Nov. 15, 2000.

(51) Int. Cl. G09B 19/00

(52) U.S. Cl. 434/236

(57) ABSTRACT

A training method for an individual to increase an individual's attention to his or her present environment and surroundings comprises maintaining a deliberate awareness of the surroundings, consciously employing one or more of the five senses, being active, and allowing only thoughts about the input from the senses. Conscious and deliberate awareness and focus develops into an automatic tendency, that is, a habit, to maintain focus on the individual's environment without distraction. The method requires special attention during short duration activities which are highly automatic, such as getting a drink from the refrigerator, and activities which require little or no thought, such as watching TV. Since these activities require little or no participation, the individual must make a deliberate effort to be aware of peripheral stimuli to the senses in addition to being conscious of activities. Conscious and deliberate awareness of peripheral information develops into an automatic tendency or habit to be oriented to time and place. By anticipating and recognizing events of high personal value, which bring with them self-imposed stress and also result in decreased energy levels, the method can be utilized immediately before entering these high value events. Also, by placing these events in proper perspective and not exaggerating their importance, the individual will thereby prevent triggering of anxiety. The method should be used as often as possible to create positive reinforcement of good habits and avoid resistance from inattention. The individual should pay attention to note improvement in subjective feeling of well-being while employing the method. This method can be used by individuals and provides adaptations for use in interpersonal relationships and parent/child relationships.

### CROSS-REFERENCE TO RELATED APPLICATION

This application claims the benefit of U.S. Provisional Application No. 60/248,927 filed on Nov. 15, 2000.

### BACKGROUND OF INVENTION

1. Field of the Invention

The present invention is directed to a training method, which is particularly useful for attention training for individuals. Although the method of this invention was derived through research in the field of treatment for psychological disorders, it is not limited to treatment of psychological disorders, but can also be used for overall general development and improvement of physical and mental well-being.

2. Background Information

The number and diversity of theories and treatments available to deal with psychological symptoms only leads one to believe that no one is really sure of how to handle them. This diversity, from the medical model to Freudian theory only serves to confuse the public. Such confusion results in fear and avoidance of intervention, only participating when there is no alternative. People see the need for psychological intervention as an embarrassment, a character deficit they wish to hide for fear of criticism or ostracism. The medical community regards psychology as inferior and insurance companies limit reimbursement since psychological intervention may frequently be vaguely defined and open-ended.

In reality, psychological intervention should be as predictable as a well-defined medical or dental procedure. Lay persons should understand what is causing symptoms and should know what to expect before they begin treatment. This predictability would remove the fear from psychological intervention and give the profession the status it deserves.

The historical approach to symptoms is to distinguish differences and cluster them into various types of disorders. A search for causes for each of the disorders then ensues. If none can be found, the medical profession frequently declares the disorders to have a genetic origin or to be the result of a biochemical imbalance. In any regard the primary method used to describe symptoms is to measure differences among them in terms of content, intensity, frequency, and duration.

According to J. Kabat-Zinn, L. Lipworth and R. Burney, “The Clinical Use of Mindfulness Meditation for the Self-Regulation of Chronic Pain,” J. of Behav. Med., Vol. 8, pp. 163-190 (1985), different approaches to the treatment of chronic pain such as progressive relaxation, biofeedback, operant conditioning, hypnosis, and cognitive-behavioral therapies all subscribe to the therapeutic value of attention regulation. Perhaps not surprisingly, the past two decades have seen a rapid rise and proliferation of mindfulness-based stress reduction programs that are based on education of the individual rather than a clinical treatment model (P. Salmon, S. Santorelli & J. Kabat-Zinn, “Intervention Elements Promoting Adherence to Mindfulness-Based Stress Reduction Programs in the Clinical Behavioral Medicine Setting,” in S. A. Shumaker et al., The Handbook of Health Behavior Change, pp. 239-66 (2d ed. 1998)). Partly in response to these developments, mindfulness has been proposed as a core psychotherapy process in J. R. Martin, “Mindfulness: A Proposed Common Factor,” J. Psychotherapy Integration, Vol. 7, pp. 291-312 (1997), and mindfulness meditation has been suggested both as a valuable part of the therapeutic process in G. A. Marlatt & J. L. Kristeller, “Mindfulness and Meditation,” in W. R. Miller et al. (Eds), Integrating Spirituality Into Treatment: Resources for Practitioners, pp. 67-84 (1999) and as an effective cognitive approach to the development of self-awareness in J. Kutz, J. Z. Borysenko & H. Benson, “Meditation and Psychotherapy: A Rationale For the Integration of Dynamic Psychotherapy, the Relaxation Response, and Mindfulnes Meditation,” Am. J. of Psychiatry, Vol. 142, pp. 1-8 (1985).

The training of mindfulness skills to enhance attentional control has also been adopted as an important component in the treatment of depression (J. Teasdale, Z. Segal & J. M. G. Williams, “How Does Cognitive Therapy Prevent Depressive Relapse and Why Should Attentional Control (Mindfulness) Training Help?,” Behav. Res. & Ther., Vol. 33, pp. 25-39 (1995)) and in dialectical behavior therapy for the treatment of borderline personality disorder (H. Heard & M. Linehan, “Dialectical Behavior Therapy: An Integrative Approach to the Treatment of Borderline Personality Disorder,” J. Psychotherapy Integration, Vol. 4, pp. 55-82 (1994); M Linehan, “Skills Training Manual for Treating Borderline Personality Disorder,” (Guild Press 1993). Linehan instructs the student to learn to be in control of his own mind by noting “what one pays attention to and how long one pays attention to it.”

According to Kabat-Zinn et al. (1985), mindfulness is clearly a generic term encompassing a range of techniques and traditions all utilizing attention though directing it to quite different objects. The same authors also suggested that the intensity and regulation of one's attention may be more important than the particular object or process attended to, and that the importance of attention regulation has generally been underestimated. Kabat-Zinn's and Teasdale's techniques both call for maintaining attention on one particular focus, commonly one's own breathing. When attention wanders, the student acknowledges the thoughts or feelings, lets go of them, and re-directs attention back to his breathing. Neither technique gives further specific information

The model presented here assumes that the development of an habitual flight response involving both intentional and automatic attentional processes is the core cause for the development of psychological problems. This dysfunctional habit consists of a reflex-like decrease in, and withdrawal of, attention from the here and now. It usually develops during childhood and/or adolescence in social environments where expressions of personal tastes are frequently met with failure, criticism, and/or punishment.

### SUMMARY OF THE INVENTION

The present invention discloses a method to practice conscious and deliberate awareness and focus on an individual's activities and surroundings and to develop the habit of maintaining focus without distraction. It also calls for conscious and deliberate awareness of peripheral information to develop the automatic tendency or habit to be oriented to time and place. The method is particularly useful for attention training of individuals.

The training method of the present invention is directed to building a new habit that restores an individual's natural tendency to maintain sensory contact with their environment in the here and now. The first phase (i.e., the “Four Points”), focuses on object attention and conscious thoughts. Individuals are taught to consciously monitor what they attend to and to increase their awareness of all sensory inputs in the here and now. The second phase, (i.e. “Taking Back Small Times”), deals with receptive attention and orienting thoughts. Individuals are asked to focus attention on everyday behaviors that are normally engaged in automatically and with little awareness. They are also asked to widen their attentional field by becoming aware of peripheral stimuli without losing their attentional focus. The training method of this invention can be taught to individuals or groups of individuals.

### DETAILED DESCRIPTION OF THE INVENTION

The approach to symptoms used in deriving the present invention is the reverse of the prior existing art. Instead of looking for differences among symptoms, the approach used to develop the present invention was to look for similarities. Although symptoms vary tremendously, there is one similarity all individuals experience. The common factor was discovered to be a decrease in attention or awareness of one's surroundings and some degree of loss of contact with their environment just prior to the onset of symptoms. Perceptual input significantly decreases and the individual experiences some degree of disorientation to the present and is less able to behave appropriately. This loss of attention is reflexive in nature and appears to be common to all individuals who suffer psychological symptoms. Work toward a standardized intervention method was begun, with the goal to achieve predictability and legitimacy for the new method of treatment.

Intelligence is measured by a person's ability to evaluate his current environment. Intelligence is composed of two parts; the thinking part which possesses the higher functions such as logic, problem solving, creativity, etc.; and the physical part which is made up of the five senses. The two major characteristics of intelligence are: first, intelligence is capable of noticing differences between situations; and second, intelligence is capable of adjusting behavior to the differences noticed.

Attention is the mechanism or method which allows the individual to maintain contact with, observe, and be aware of the current environment. Attention can be quantified and may vacillate from sharp focus on surroundings to complete inattention; for example, the latter occurs while daydreaming.

Expression is one's interaction with the present or current environment. Expression occurs in three modes: physical movement; speech; and thought.

Expression is frequently suppressed by individuals out of fear of negative judgment, mainly by offending or angering others. The resulting apprehension draws a person's attention away from his surroundings and toward his fear of expression. This negative habit feeds on itself and is too fast to be consciously controlled. It may then lead to further problems such as anxiety or depression.

The present invention goes beyond prior approaches by postulating that intentional and automatic attentional processes are the only processes that are of critical importance for an understanding of psychological health and psychological problems. Specifically, it proposes that a reflex-like or automatic attentional habit, dysfunctional in nature and developed in response to certain environmental conditions or events, constitutes the common core that underlies a wide range of psychological disorders and symptom manifestations. Consequently, the present intervention technique involves the training of individuals in the re-deployment of attention to pre-empt the dysfunctional attentional habit. This approach offers several practical advantages. First, it is presented as an educational rather than a treatment program. Second, it is manually based and standardized across a wide range of disorders. Third, it can be administered not only individually but also in groups. Fourth, it has equal applicability across different cultures and subcultures.

A. Intelligence, Attention, and Psychological Health

Human beings, as open living systems, are born with a natural tendency to direct attention outward. Sensory stimulation is necessary for normal development and functioning and is, for the most part, intrinsically pleasurable. Intelligence—an individual's capacity to interact competently with his/her environment—cannot function at an optimal level unless attention is directed outward, thereby letting the individual maintain full sensory contact with his/her environment and producing awareness of the here and now. Consistent with current dual-process models (e.g., S. Chaiken & Y. Trope (Eds.), “Dual Process Theories in Social Psychology” (Guilford Press 1999)) intelligence is assumed to function simultaneously at two interrelated levels. At the level of primary-process thinking (Kutz et al., 1985), orienting thoughts are automatic and non-conscious (J. A. Bargh & T. L. Chartrand, “The Unbearable Automaticity of Being,” Am. Psychologist, Vol. 54, pp. 462-79 (1999)). Orienting thoughts contain perceptions and concepts of familiar events and situations providing the individual with a style of behavior and an efficient and economical use of well-learned behaviors and skills in those situations. Orienting thoughts maintain contact with the environment through what has been called the receptive mode of attention. See A. J. Deikman, The Observing Self (Beacon Press 1982). At the secondary-thinking level (Kutz et al., 1985), intelligence involves conscious thoughts that prompt an individual's intentional and purposeful actions. Conscious thoughts generally maintain contact with the environment through what Deikman (1982) called the object mode of attention. While receptive attention is ideally always oriented towards the present, external environment, intelligent thinking does not require that object attention is also always focused solely on the here and now. For instance, when an individual is engaged in planning, object attention is temporarily focused on specific future events, decisions are made and object attention readily returns to the here and now. Similarly, memory implies that object attention is temporarily focused on specific events in the past, decisions are made concerning the relevance of the past events with regard to the individual's present or future, and object attention again readily returns to the here and now. Finally, reminiscing involves a temporary redirection of object attention towards pleasurable events in the past followed by a return to the here and now. In that sense, all intelligent thinking is positive and based in reality.

Psychological health is not possible without effective intelligent functioning. It requires that orienting thoughts maintain contact with the here and now through receptive attention towards the external environment, thus priming the individual to be open and sensitive to sensory inputs in the here and now. The resulting sensory perceptions supply relevant information to conscious thought allowing the individual to be oriented to space and time, to direct object attention towards the task at hand, to perceive differences between situations, to be sensitive to his/her physical-social context and, thus, to engage in appropriate behavioral responses. To the extent that receptive attention is oriented towards the present, external environment, object attention can be employed effectively and intelligence functions optimally. Furthermore, the individual experiences his/her own behaviors (including locomotor behavior, verbal behavior, and thoughts) as conflict-free expressions of personal tastes, that is, personal likes and dislikes, constrained only by personally and socially accepted rules and norms. As will be elaborated below, intelligent functioning decreases and psychological health becomes compromised in direct proportion to the degree to which receptive and object attention are withdrawn from the external environment and the expression of personal tastes is suppressed. Therefore, it becomes important to understand the nature of the mechanism that redirects attention away from the external environment as well as the events and conditions that contribute to its development and maintenance.

B. Reflexive Attention Diversion (RAD)

Human beings are born into a social environment and are gradually incorporated into meaningful social groups where members share common cultural values and are expected to adhere to common social rules and to be considerate of each other. At the same time, such social environments allow or even foster the development of a diversity of personal tastes and interests and their expression in individuals' behavior. Ironically, however, the social environment is such a powerful force that it can also have a negative impact making it difficult or even impossible for individuals to express their personal tastes and interests without experiencing internal conflict.

The development of personal tastes and interests begins in childhood. According to Newman and Newman (1984), toddlerhood is a period of high activity levels when children want to do things “on their own”. That is, a good deal of children's behavior between the ages of about 2 to 4 is an expression of quests for personal autonomy. During the ages from 5 to 7, children begin to exhibit increasing levels of curiosity and behavior becomes an expression of personal experimentation. During late childhood (ages 8-12) children become increasingly motivated to build skills and behavior becomes an expression of personal competence and mastery. A sense of personal autonomy, curiosity and experimentation, and a sense of competence are the psychological foundations for the development and expression of personal tastes and longer-lasting interests.

Parents who are the primary caregivers of children may respond in different ways to their children's expressions of autonomy and curiosity. See e.g., Baumrind, D. “Child Care Practices Anteceding Patterns of Preschool Behavior,” Genetic Psychology Mongraphs, 75, 43-88 (1967); Maccoby, E. E. & Martin, J., “Socialization in the Context of the Family: Parent-Child Interaction,” in P. H. Mussen & E. M. Hetherington (Eds.), Handbook of Child Psychology, Vol. 4: Socialization, Personality, and Social Development (4^{th}. ed., pp. 1-101) (1983). Authoritative parents provide a balance of guidance and support for their children's expressions of autonomy and curiosity and the child will learn that such expressions are mostly pleasurable experiences. In contrast, authoritarian and overprotective parents tend to respond to their children's expressions of autonomy and curiosity with punishment, criticism, and/or discouragement. By failing to provide proper guidance and support, permissive and/or neglectful parents make it more likely that their children experience too many unnecessary failures in their attempts to express autonomy. Failure, punishment, criticism, and discouragement are likely to elicit fear and/or shame and guilt in the child (Newman & Newman, 1984). These emotions, in turn, trigger a flight response that is primarily attentional in nature. It involves, at least initially, a decrease in, and redirection of, object attention away from the environment. If these negative consequences are experienced sufficiently frequently and the associated negative emotions are sufficiently intense, the child will come to believe that expressions of personal tastes are to be suppressed in order to avoid negative consequences. More importantly, however, with sufficient repetition these beliefs become automatic and non-conscious orienting thoughts. They prime the child to view all social comparisons and differences in opinion between self and others as criticisms, to withhold or suppress the expression of anger specifically and of personal tastes more generally and to be apprehensive towards the here and now. Moreover, the flight response itself becomes a reflex-like or automatic habit involving a decrease in receptive attention towards the external environment (i.e. RAD), and thereby reducing sensory contact with the environment in the here and now.

As stated before, human beings share with all living systems the characteristic of being open systems with a natural tendency to direct attention towards the external environment. RAD as an automatic and non-conscious habit, however, functions in direct opposition to that natural tendency. As a result, RAD produces internal tension that is experienced as psychological discomfort and negative affect. The greater the frequency and pervasiveness of the RAD response, the more intense and pervasive the discomfort that is experienced. Eventually, the individual becomes motivated to identify the source of that discomfort. However, because RAD is non-conscious it cannot be identified as the source of that discomfort. In addition, because sensory contact with the external environment is reduced, intelligent functioning becomes less effective. Failure to identify the source of discomfort compels the individual to redirect more and more object attention inwards thus further reducing contact with the external environment. In addition, negative effect produces a narrowing of attention and a failure to consider alternatives (Fiedler, 1988). The senses literally recede, less information is obtained from the environment in the here and now, and behavior becomes tense and awkward. With increasingly less attention directed towards the present environment, the individual becomes more disoriented to time and space. Memory and problem solving become impaired and information-processing becomes increasingly mindless (e.g., Teasdale et al., 1995); i.e., removed from the here and now. Unable to find a source of the discomfort in the present environment, the individual begins to engage in “out-of-control” thinking characterized by thoughts that are increasingly detached from the present and aimed at fabricating a justification for the experienced discomfort, that is, “identifying the enemy”. In other words, RAD leads to “out-of-control” thinking that is always negative, fails to result in any useful decision, and resists a return to the here and now.

The negative content of “out-of-control” thoughts triggers a sequence of negative emotions that have no readily identifiable source in the present, external environment. Experienced first is typically anxiety. To reduce that anxiety, the individual begins to engage in avoidant behaviors. Such behaviors serve to temporarily relieve anxiety but also to suppress the expression of personal tastes. As a consequence, avoidant behaviors will eventually produce depression. That is, deprived of the free expression of personal tastes and the intrinsic pleasure that derives from it, the individual comes to feel hopeless and helpless believing that he/she has not been happy in the past and will never be happy in the future. Over time, depressed individuals come to feel trapped and controlled. Feelings of being trapped and controlled may then generate anger that the individual will hold back for fear of negative consequences. However, a continued suppression of such anger has the cumulative effect of spawning uncontrolled angry outbursts whose intensity is typically out of proportion to the triggering events. These outbursts may be directed outward towards the environment or inward towards the self and will often make the individual feel self-critical, thus further reinforcing the RAD.

Overall then, RAD and its automatic and non-conscious functioning are assumed to be a common cause of emotional disorders characterized by manifestations of anxiety, avoidance, depression, and anger. However, most individuals are not likely to exhibit symptoms of anxiety, depression, and anger simultaneously. Instead, it is more common that they manifest symptoms primarily in one of these areas. Nevertheless, since RAD is assumed to be the initial stage in this psychopathic sequence, interventions must be aimed at RAD rather than the various symptoms in order to be effective.

C. Attention Training

The training program described here is based on the premise that stimulation to the senses is intrinsically pleasurable and that sensory pleasure can be experienced only if attention is directed towards the environment. RAD, in contrast, is an automatic habit that withdraws attention from the environment thus depriving the individual of sensory pleasures and producing discomfort. The overall objective of the program is not to weaken the RAD habit but, instead, to build a new habit by restoring and strengthening the individual's natural tendency to direct attention outward at the level of both conscious and orienting thoughts. As stated above, it is envisioned that the new habit is intrinsically rewarding and, once it has gained sufficient strength, will become dominant over the RAD habit. The program begins by giving an individual a description of RAD, what it is, how it works, how it generates a sequence of negative emotions and symptoms, and how to identify “out-of-control” thinking and avoidant behavior. The individual is also made aware of the distinction between negative emotions brought on by RAD and “normal” negative emotions with an identifiable source in the environment. The latter include warranted anger in response to being treated unfairly, fear in response to physical threats, nervousness in situations with social consequences of high, personal value, and reactive depression in response to personal losses. Attention training itself is then presented in two phases involving two distinct objectives.

1. Phase One: the Four Points

The first phase, the “Four Points” is intended to redirect object attention towards, and thereby increase awareness of, the present external environment. Individuals are asked to monitor their attention and to focus it deliberately and consciously on ordinary external stimuli by performing the Four Points as continuously and frequently as possible. It is stressed that frequent repetition is the key to building up the new attentional habit or style. The Four Points are:

(1) Consciously orient to time and place. The individual is asked to consciously know and understand where he or she is and what is occurring around them at all times.

(2) Consciously and deliberately employ one or more of the five senses. The individual is instructed to consciously be aware of stimuli such as seeing clouds, feeling a breeze, hearing children play, smelling flowers or tasting food. The individual is asked to emphasize the visual, tactile, and auditory senses, especially in familiar situations such as at home.

(3) Activity. The individual should be active to reduce avoidant thinking or drifting in low stimulation situations. The individual is instructed to be active. Activity that requires attention and participation helps to focus object attention towards the environment. The individual is warned that passivity or mindless activity allows avoidant thinking. Individuals are instructed that whenever they become aware of avoidant thinking to interrupt it with simple activities such as getting a glass of water or phoning a friend.

(4) Only allow thoughts that are concerned with the here and now and what is impinging on the senses. Individuals are instructed to consciously and deliberately try to allow only thoughts that pertain to the immediate environment to block out-of-control thinking. Out-of-control or RAD thinking involves thoughts that are detached from the environment in the here and now and preoccupied with the future, the past, and/or what others may be thinking. Thoughts about the future tend to generate anxiety and individuals are asked to self-instruct as follows: “If I can't see, hear, smell, touch or taste it, it doesn't exist. I'll handle it if and when it happens but I'm not going to worry about it now.” Thoughts about the past tend to generate depression and individuals are asked to self-instruct as follows: “It's over. There is nothing I can do about it.” Mind-reading thoughts also tend to produce anxiety and are counteracted with the self-instruction: “If the person doesn't say it, he/she is not thinking it.”

Individuals are asked to perform the Four Points as frequently as possible. They are cautioned not to expect dramatic changes but, instead, to notice periods of slight relief and comfort whenever attention is focused on the external environment. In contrast to other treatment approaches, individuals are instructed to ignore all negative thoughts and symptoms brought on by RAD and to keep attention focused on the present, external environment.

Performance of the Four Points is likely to encounter five resistances. First, individuals may forget to practice the Four Points. Therefore, they are asked to write down the Four Points, to make copies of them and to leave them in familiar places as reminders. Second, individuals may believe that they are too busy to practice the Four Points. Therefore, they are instructed to apply the technique while engaged in everyday activities in order to develop a style of doing everything with attention. Third, individuals may “feel fine” and become complacent thinking that further practice is unnecessary. Therefore, they are made aware of the possibility of relapses. Fourth, individuals may believe that practicing the Four Points is not necessary in familiar situations and need to be instructed that it is actually easiest in such situations. Fifth, individuals may find the technique too simplistic. In that case, individuals are asked to examine their subjective sense of well-being whenever they apply the technique.

Individuals are also informed to be mindful of their energy levels since reduced energy will lessen the ability to be attentive. In particular, three conditions are identified as pressures that lower energy levels. Two of these pressures are physical in nature and include: (a) illness and/or normal medical conditions such as pregnancy and monthly menstrual cycles; and (b) fatigue. In both cases, reduced energy levels lead to decreased attention toward the environment and, thus, to RAD thinking. Individuals are asked to anticipate such conditions and when experiencing them, to identify the source of subjective discomfort as a physical one, to rest and/or to curtail all activities that are not essential. The third pressure is psychological in nature and involves events of high personal value. Individuals are asked to place such events in proper perspective in order to counteract the RAD induced tendency to take these events too seriously and, thereby, to prevent the triggering of anxiety.

A period of approximately three to five weeks of practicing the Four Points

is usually necessary to develop and maintain increased levels of object attention towards the environment. However, reduced energy from any of the above mentioned pressures may cause a relapse, a temporary period of time when an individual's attention is decreased and directed inwards with a resulting return of symptoms. The second phase is designed to prevent such relapses.

2. Phase Two: Taking Back Small Times

The second phase of the attention training program is aimed at restoring the natural tendency of receptive attention to maintain contact with the present, external environment. Unless an individual's orienting thoughts can be shaped to maintain contact with the environment through receptive attention, the conscious efforts of redirecting object attention towards the external environment will eventually fade. Therefore, the second phase represents an attempt to make an individual aware of some of his or her orienting thoughts in two ways. First, the individual is instructed to become aware of small times, that is, times in between events, times characterized by high automaticity and low awareness. For instance, while sitting on the couch and watching TV, the individual decides to go to the refrigerator to get a beer. Getting up and walking to the refrigerator is usually a highly automatic behavior involving little awareness: i.e., it is a small time. Second, the individual is instructed to make an effort to become more aware of peripheral sensory inputs at the same time that their object attention remains focused on a task, that is, the individual is asked to practice a widening of his or her attentional field. Again, individuals are asked to practice “Taking Back Small Times” continuously and as frequently as possible. A period of approximately four to six weeks of practice is usually necessary to prevent relapses to the old RAD habit.

Motivation appears to be the single most important factor determining the success of the training program. However, even when an individual's motivation is initially low, hesitations are often overcome and motivation substantially enhanced due to the following factors. First, individuals appreciate the fact that they are not asked to disclose private confidential information about themselves nor to reconstruct potentially painful experiences in their past. Second, individuals including those with little or no knowledge of psychology, find the conceptual model of RAD and its effects logical and easy to understand. Third, individuals find comfort in the notion that their symptoms are not the manifestation of deep seated psychological deficiencies but, instead, the result of a bad habit that can be overcome by learning a set of attention related skills and building a new habit. In other words, the program is viewed more as an educational program than as a psychological intervention.

Attention training as described above is difficult for young children. However, parents can be taught to incorporate the central principles of the program into their child-rearing practices. Specifically, parents are trained: (1) to encourage their children to make choices and decisions in child-appropriate everyday situations, to accept those decisions without any negative criticism or punishment and, if necessary, to help them understand the consequences of their decisions; and (2) to help their children practice the Four Points. Attention training has also been adapted for couples. Partners are taught to express personal opinions to each other and to recognize mutual differences as differences in points of view rather than as mutual criticism. They are also taught to help each other practice the Four Points and to become aware of negative RAD thinking in the form of mind-reading and dwelling on past negative events.

The training method of this invention does not attempt to control the negative habit, but instead enables the individual to build a new intelligent habit which will compete with and override the negative habit. There are three adaptations of the training program, one for individuals, one for interpersonal relationships, and one for parent/child relationships. All have the same purpose: to increase attention toward the surrounding environment. The concept is simple—if attention directed toward the surrounding environment is not allowed to decrease, then negative thoughts and attitudes cannot be generated and symptoms cannot occur. The training program creates a new habit or reflex in the body. This process occurs by way of the pleasure principle and the body's natural tendency and desire to have contact with its surrounding environment.

The invention claimed herein is a method to train an individual to increase his or her attention to his present environment and surroundings. If attention directed toward the present environment is maintained at a higher level, the mind remains focused and will not wander. Negative thoughts and attitudes cannot be generated, and therefore detrimental symptoms or negative habits will not occur. The program has many uses, some of which are: to create a positive attitude; boost self-confidence and self-esteem; increase productivity; increase physical and mental well-being; and to eliminate or reduce psychological, behavioral and/or personality disorders. This method can be used by individuals and adapted for use in interpersonal relationships and parent/child relationships.

The method for individuals comprises the following:

(a) Maintaining a deliberate awareness of the surroundings, being oriented to time and place, and being conscious of what is happening around the individual;

(b) Employing consciously and deliberately one or more of the five senses and being aware of the environmental stimuli or input received from the senses, such as seeing clouds, feeling a breeze, hearing children play, smelling flowers, or tasting food;

(c) Engaging and maintaining activity. Activity that requires attention and participation helps the individual to focus on the surroundings, thereby minimizing daydreaming or dazing off. If daydreaming or drifting thoughts should occur, the method calls for breaking it off immediately by performing an activity, such as getting a glass of water or phoning a friend; and

(d) Allowing only thoughts about sensory inputs; that is, thoughts about the surroundings or the activity being performed (e.g. seeing, hearing, smelling, tasting, or touching).

Conscious and deliberate awareness and focus develops into an automatic tendency, that is, a habit, to maintain focus on the individual's environment without distraction. The individual should pay attention to an increase in pleasure or relief of discomfort, and improvement in his or her subjective feeling of well-being while practicing the method and maintaining focus.

The individual is further instructed to pay special attention to short duration activities which are highly automatic such as getting a drink from the refrigerator and activities which require little or no thought, such as watching TV. Since these activities require little or no participation, individuals must make a deliberate effort to be aware of peripheral stimuli to the senses in addition to being conscious of their activities. Conscious and deliberate awareness of peripheral information develops into an automatic tendency or habit to be oriented to time and place. Again, the individual should pay attention to an increase in pleasure or relief of discomfort, and improvement in his or her subjective feeling of well-being while increasing awareness through practicing the method.

The individual should use the following techniques to reinforce the method, develop it as a habit, and avoid resistance from inattention:

(a) Retaining copies of the Four Point method everywhere that is necessary as a reminder to practice the method and develop the good habit of practicing it;

(b) Performing the method even if busy, stressing that the individual should never say he or she is too busy to maintain focus on surroundings and activities;

(c) Practicing the method even while at home or in other comfortable situations, since this will reinforce the habit of practicing the method;

(d) Practicing the method all the time, especially when feeling good, which serves two functions:

1. It is easier to develop the method into a habit by practicing during good times, since there is little resistance from negative thoughts; and

2. It is easier to use the method to remain in a good state of mind than it is to intervene during times when the individual feels the need for the method; and

(e) Refraining from doubting the method's value and effectiveness because of its simplicity, and having the individual note its positive effect by evaluating one's subjective sense of well-being while he or she is practicing the method.

The individual is further instructed to anticipate or recognize periods of low energy and to rest and curtail all non-essential activities during these periods. Examples of low energy periods are fatigue, illness, and normal physiological conditions such as pregnancy and monthly menstrual cycle. Low energy levels lead to decreased attention levels, making it more difficult to practice the method.

The individual is advised to anticipate and recognize events of high personal value. These events bring with them self-imposed stress and also result in decreased energy levels. The individual should employ the method immediately before entering these high value events. Also, by placing these events in proper perspective and not exaggerating their importance, the individual will thereby prevent triggering of anxiety.

The person is further instructed to notice an increase in pleasure or relief of discomfort, and improvement in his subjective feeling of well-being while performing any or all aspects of the method.

The application of the method for interpersonal relationships comprises the following points:

a. Stressing that past events are no longer important and individuals begin a new relationship from the time of intervention;

b. Allowing individual expression and taking each other at their word without reading into them;

c. Expressing differences and remembering that differences of opinions are points of view, not angry acts meant to offend; and

d. Performing activities together.

The method for interpersonal relationships may be used without the training method for individuals, but is more effective when used in conjunction with it. It is most effective when the parties also assist each other in practicing the training method for individuals.

The application of the method for parents to use with children comprises the following points:

a. Clearly explaining the parent's expectations to the child;

b. Informing the child of the alternatives open to him or her;

c. Informing the child of the consequences of each choice;

d. Allowing the child to make his or her own choice; and

e. Administering the consequences fully, always without anger, as follows:

1. Positive consequences for appropriate behavior include allowing the child to enjoy his free time to do as he or she likes, under the structure of child rearing;

2. Negative consequences for inappropriate behavior include periods of various duration (depending on the child's age) in which free time is forfeited and the child is not allowed to engage in any activity, in order to create boredom.

Anger is never used toward the child since it triggers the fight/flight response and will cause the child to develop symptoms such as fear of negative judgment, anxiety, suppression of expression, and depression.

The method teaches the child to:

a. Be responsible for his or her behavior;

b. Be decisive;

c. See differences of opinion as points of view, not as angry acts;

d. Develop the skill of tactful expression;

e. Develop tastes into interests; and

f. Most importantly, be confident.

The method for parents to use with children may be used with or without the training method for individuals, but is more effective when parents use them in conjunction with each other. It is most effective when the parent also helps the child to practice the training method for individuals.

The training method of the invention permits the individual user to maintain a higher level of attention directed toward the present environment. The mind remains focused and will not wander. Negative thoughts and attitudes cannot be generated, and therefore detrimental symptoms or negative habits will not occur.

The method has many additional uses, some of which are: to improve a person's state of mind; improve mental and physical well-being; create a positive attitude; boost self-confidence and self-esteem; increase productivity, reduce job-related injuries, and to prevent, eliminate or reduce psychological, behavioral and/or personality disorders. The method may be used for any application that will provide benefit in an increase of an individual's attention and/or focus.

The invention claimed is:

1. A training method for an individual which comprises:
(a) maintaining a deliberate awareness of the individual's surroundings, being oriented to time and place, and being conscious of what is happening around the individual;
(b) employing one or more of the individual's five senses and being aware of the environmental stimuli or input received from the senses;
(c) engaging and maintaining individual activity;
(d) allowing only thoughts about sensory inputs received by the individual's senses; and
(e) noticing an increase in the individual's pleasure or relief of discomfort, and improvement in the individual's subjective feeling of well-being while practicing the method.

2. The method of claim 1 further comprising:
paying special attention during activities which are highly automatic;
making a deliberate effort during the activities to be aware of peripheral stimuli to the senses and to be conscious of activities performed;
paying attention to an increase in pleasure or relief of discomfort, and improvement in the individual's subjective feeling of well-being while increasing awareness through practicing the method.

3. The method of claim 2 further comprising the following:
retaining copies of the method everywhere that is necessary to remind the individual to practice the method and develop the habit of practicing it;
performing the method when the individual is busy;
practicing the method when the individual is at home or in other comfortable situations; and
practicing the method when the individual is feeling good;

4. The method of claim 3 further comprising:
anticipating or recognizing events of high personal value to the individual;
employing the method immediately before entering the high value events; and
placing these events in proper perspective, thereby reducing cause for anxiety.

5. The method of claim 4, wherein the method is applied to interpersonal relationships, and additionally further comprises the following:
stressing that past events are no longer important and individuals begin a new relationship from the time of intervention;
allowing individual expression and taking each other at their word without reading into them;
expressing differences without being offended by other opinions;
performing activities together; and
assisting each other in the practicing the training method.

6. The method of claim 4, wherein the method is applied by a parent to a child, and additionally further comprises the following:
clearly explaining the individual's expectations to a child;
informing the child of the alternatives open to him or her;
informing the child of the consequences of each choice;
allowing the child to make his or her own choice; and
administering the consequences fully, without anger, as follows:
(1) administering positive consequences for appropriate behavior; and
(2) administering negative consequences for inappropriate behavior; and
assisting the child in practicing the training method.

7. A training method for interpersonal relationships for individuals which comprises:
(a) stressing that past events are no longer important and individuals begin a new relationship from the time of intervention;
(b) allowing individual expression and taking each other at their word without reading into them;
(c) expressing differences without being offended by other opinions; and
(d) performing activities together.

8. A training method for a parent to administer to a child, which comprises:
(a) clearly explaining the parent's expectations to the child;
(b) informing the child of the alternatives open to him or her;
(c) informing the child of the consequences of each choice;
(d) allowing the child to make his or her own choice; and
(e) administering the consequences fully, without anger, as follows:
(1) administering positive consequences for appropriate behavior; and
(2) administering negative consequences for inappropriate behavior.
